(19) United States
(12) Patent Application Publication
(10) Pub. No.: US 2021/0241310 A1
(43) Pub. Date: Aug. 5, 2021

(54) INTELLIGENT ADVERTISEMENT CAMPAIGN EFFECTIVENESS AND IMPACT EVALUATION

(71) Applicant: INTERNATIONAL BUSINESS MACHINES CORPORATION, Armonk, NY (US)

(72) Inventors: Joao H BETTENCOURT-SILVIA, Dublin (IE); Stefano BRAGHIN, Dublin (IE); Michalis PACHILAKIS, Crete (GR)

(73) Assignee: INTERNATIONAL BUSINESS MACHINES CORPORATION, Armonk, NY (US)

(21) Appl. No.: 16/777,216

(22) Filed: Jan. 30, 2020

(51) Int. Cl. G06Q 30/02; G06N 20/00; G06N 5/04

(52) U.S. Cl. CPC G06Q 30/0246; G06N 5/04; G06N 20/00; G06Q 30/0251

(57) ABSTRACT

Embodiments for implementing intelligent advertisement effectiveness and impact evaluation in a computing environment by a processor. A degree of impact and a degree of distribution of one or more communication campaigns upon a targeted entity may be identified according to a user persona, one or more communication rules, security factors, or a combination thereof.

### BACKGROUND OF THE INVENTION

### Field of the Invention

The present invention relates in general to computing systems, and more particularly, to various embodiments for providing intelligent advertisement campaign effectiveness and impact evaluation in a computing environment by a processor.

### Description of the Related Art

In today's society, consumers, business persons, educators, and others use various computing network systems with increasing frequency in a variety of settings. The advent of computers and networking technologies have made possible the increase in the quality of life while enhancing day-to-day activities. Computing systems can include an Internet of Things (IoT), which is the interconnection of computing devices scattered across the globe using the existing Internet infrastructure.

As great strides and advances in technologies come to fruition, these technological advances can be then brought to bear in everyday life. For example, the vast amount of available data made possible by computing and networking technologies may then assist in improvements to quality of life.

### SUMMARY OF THE INVENTION

Various embodiments for providing intelligent advertisement effectiveness and intelligent advertisement effectiveness and impact evaluation impact evaluation in a computing environment by a processor are provided. In one embodiment, by way of example only, a method for providing intelligent advertisement effectiveness and impact evaluation in a computing environment by a processor is provided. A degree of impact and a degree of distribution of one or more communication campaigns upon a targeted entity may be identified according to a user persona, one or more communication rules, security factors, or a combination thereof.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram depicting an exemplary computing node according to an embodiment of the present invention;

FIG. 2 is an additional block diagram depicting an exemplary cloud computing environment according to an embodiment of the present invention;

FIG. 3 is an additional block diagram depicting abstraction model layers according to an embodiment of the present invention;

FIG. 4 is a diagram depicting various user hardware and computing components functioning in accordance with aspects of the present invention;

FIGS. 5A-5B are block diagrams depicts providing intelligent advertisement effectiveness and impact evaluation in a computing environment according to an embodiment of the present invention; and

FIG. 6 is a flowchart diagram of an exemplary method for providing intelligent advertisement effectiveness and impact evaluation in a computing environment by a processor, in which various aspects of the present invention may be realized.

### DETAILED DESCRIPTION OF THE DRAWINGS

As a preliminary matter, computing systems may include large scale computing called “cloud computing,” in which resources may interact and/or be accessed via a communications system, such as a computer network. Resources may be software-rendered simulations and/or emulations of computing devices, storage devices, applications, and/or other computer-related devices and/or services run on one or more computing devices, such as a server. For example, a plurality of servers may communicate and/or share information that may expand and/or contract across servers depending on an amount of processing power, storage space, and/or other computing resources needed to accomplish requested tasks. The word “cloud” alludes to the cloud-shaped appearance of a diagram of interconnectivity between computing devices, computer networks, and/or other computer related devices that interact in such an arrangement.

Additionally, the Internet of Things (IoT) is an emerging concept of computing devices that may be embedded in objects, especially appliances, and connected through a network. An IoT network may include one or more IoT devices or “smart devices”, which are physical objects such as appliances with computing devices embedded therein. Many of these objects are devices that are independently operable, but they may also be paired with a control system or alternatively, a distributed control system such as one running over a cloud computing environment.

The prolific increase in use of various types of computing systems such as, for example, IoT devices within the cloud computing environment, in a variety of settings provide various beneficial uses to a user. Various computing systems and devices may be used for personal or commercial purposes such as, for example, advertisement campaigns.

A key feature desired in advertisement is targeting a market. That is, there is little, if any, short term benefit to the advertiser from sending advertisements to persons who are not likely to purchase the advertiser's product.

Health and social care advertisement campaigns require their effectiveness to be verified in terms of impact, reach and visibility. At the same time, it is important for such advertisement campaigns to identify what are the other types of communication (e.g., social media, ad campaigns on TV, etc.) the target populations are targeted with.

However, one problem in advertisement campaigns is that it is difficult to gather information about specific customer needs. Advertising agencies try to gather such information via polls that are expensive and cover only a small number of potential users. For example, advertisement agencies try to collect and provide, for example, statistics about the reach of each advertisement campaign, which is usually proportional to the cost of the campaign itself. However, such information may only be provided to the clients running the advertisement campaign. Accordingly, a need exists that allows organizations (e.g., health and social care), both public and private, to actively monitor the type of communication their target population receives and allow the identification of effective impact and visibility of the advertisement campaign on the target entity (e.g., a person, business, organization, academic institution, etc.).

Accordingly, various embodiments are provided for implementing intelligent advertisement effectiveness and impact evaluation in a computing environment by a processor is provided. A degree of impact and a degree of distribution of one or more communication campaigns upon a targeted entity may be identified according to a user persona, one or more communication rules, security factors, or a combination thereof.

In an additional aspect, the present invention provides for an intelligent system that provides intelligent advertisement campaign effectiveness and impact computing environment by a processor is provided. The intelligent system may monitor the effectiveness and necessity of advertisement campaigns in a selected domain (e.g., in the healthcare/welfare domain). The intelligent system enables the monitoring of the effectiveness of online advertisements campaign by measuring whether the expected advertisements are actually presented to one or more targeted entities or categories (e.g., target social categories). For example, the intelligent system may search various online websites (e.g., crawls the internet) to identify advertisement campaigns. The intelligent system may provide for a “client-side monitoring operation” that evaluates each advertisement communication/content served by a third party service (e.g., a third party advertisement agency) against one or more defined or stored set of rules in order to detect potential privacy breaches and/or inference attempts. An “inference attempt” may refer to “inference attack attempt”, which means an attack that tries to infer further information from what is available and provided by the user connecting to the service. In other words, an inference attempt is a type of attach by which an entity gain sensitive information about another entity from the non-sensitive information release by the second entity.

For example, consider the following use cases. In one use case, an interactive advertisement may be created in a vehicle based on a billboard. That is, a vehicle, equipped with one or more cameras, may be moving/driving on a road. The vehicle passes by an advertisement display (e.g., a billboard sign) that includes/displays a QR code. The vehicle's entertainment system prompts the driver to launch more details of the advertisement relating to the indicator.

In an additional use case, the intelligent system may determine, as the degree of distribution, a number of times the advertisement campaigns were delivered to a targeted entity in the healthcare/welfare domain.

In an additional use case, the intelligent system may monitor and evaluate advertisement campaigns using various advertisement and communication rules and security factors. The advertisement and communication rules and security factors are used to detect security breaches and inference attempts upon the advertisement campaigns.

In an additional use case, the intelligent system may extract topics, sentiments, meaning or intent, or a combination thereof based on the advertisement campaigns. The intelligent system may simulate the behavior or learned patterns of a user persona. The user persona includes a description of a user obtained from a list of uniform resource locators (URLs), a frequency and probability of the user visiting one or more of a URLs from the list of the URLs, a list of interests relating to the user, activities, behaviors, and/or patterns of the user associated with the list of the URLs, or a combination thereof. That is, the intelligent system may manage classification of the advertisement campaigns and identify an intent or type of the advertisement campaigns. The intelligent system may initialize a machine learning operation to discern the advertisement campaigns as an advertisement. Using a machine learning operation, the intelligent system may learn or extract topics, semantics, categories, intent, or a combination thereof of the advertisement campaigns. A degree of polarity (e.g., a positive polarity/positive impact or negative polarity/negative impact) of the advertisement campaigns may be identified in relation to the user person.

In one aspect, as used herein “sentiment” may be defined as a view or attitude towards a situation, event, or behavior. For example, the behavior, activities, patterns, interactions, or dialogs of an advertisement could indicate a positive sentiment while the behavior, activities, patterns, interactions, or dialogs of an advertisement could indicate a negative sentiment. That is, an advertisement of an advertisement campaign may produce a negative user sentiment while interacting, observing, consuming, and/or viewing/listing to the advertisement. Sentiment may also be defined as a feeling, emotion, attitude, or response of a user or “simulated” user persona. Sentiment can represent a full spectrum of perceptions from deeply negative to deeply positive. Sentiment may be a score that could be an absolute value, relative value, or a value within a defined range, or a percentage. An absolute sentiment value can simply be a number on a scale. A relative sentiment value represents the difference between the sentiments of two target entities (e.g., users).

The term “effective” may be defined as success in producing a desired or intended result or achieving a defined goal. The term “effective” or “effectiveness” is to be understood as qualifying an effect, in this instance a treatment. Also, the term “effective” may be defined as follows: “something that produces the expected effect.” For example, the advertisement campaign was effective in the sense that the advertisement campaign was successful in producing a desired result (e.g., a selected number of target entities 1) had the advertisement campaign both delivered to the target entities and was viewed by a defined number of those of the target entity (e.g., viewed more than 50% of the target entities). In an additional example, “effective” may be defined as an advertisement and/or an advertisement campaign that 1) is delivered to a targeted entity in one or more targeted locations, and 2) the targeted entity interacted, engaged, viewed, and/or consumed the advertisement and/or the advertisement campaign.

In an additional use case, the intelligent system includes internet URL crawler functionality customizable to simulate a persona and enable advertisement identification and topic classification.

In an additional use case, the intelligent system may obtain vantage points in virtual machines located in various geographical location. It should be noted that in the context of “vantage point,” vantage point may mean geographically distributed “location.” In one aspect, vantage point may mean that the intelligent system may benefit from the ability to be executed in virtual machines running in diverse locations and, hence, by being able to appear, from the service point of view, as operating in different geographical areas (country, city, and so on). The data may be analyzed locally in various vantage points and the extracted results may be sent to the intelligent system, which may include and/or be a centralized server for aggregation and further analysis.

In this way, the mechanisms of the illustrated embodiments of the intelligent system provide advantages of existing systems by analyzing and reporting the effectiveness of campaigns available as a commercial offering without requiring any modification at the application and/or system level. The monitoring operations of the intelligent system may be performed passively by utilizing available web services and processing the results obtained from the such services.

It should be noted as described herein, the term “intelligent” (or “intelligence”) may be relating to, being, or involving intellectual activity such as, for example, thinking, reasoning, or remembering, that may be performed using machine learning or other techniques of artificial intelligence. In an additional aspect, intelligent or “intelligence” may be the mental process of knowing, including aspects such as awareness, perception, reasoning and judgment. A machine learning system may use artificial reasoning to interpret data from one or more data sources (e.g., sensor-based devices or other computing systems) and learn topics, concepts, and/or processes that may be determined and/or derived by machine learning.

In an additional aspect, the terms intelligent or “intelligence” may refer to a mental action or process of acquiring knowledge and understanding through thought, experience, and one or more senses using machine learning (which may include using sensor-based devices or other computing systems that include audio or video devices in lieu of human senses). The word “intelligent” may also refer to identifying patterns of behavior, leading to a “learning” of one or more events, operations, or processes. Thus, the intelligent model may, over time, develop semantic labels to apply to observed behavior and use a knowledge domain or ontology to store the learned observed behavior. In one embodiment, the system provides for progressive levels of complexity in what may be learned from the one or more events, operations, or processes.

In an additional aspect, the term “intelligent” may refer to a machine learning/artificial intelligent “AI” system. The intelligent system may be a specialized computer system, or set of computer systems, configured with hardware and/or software logic (in combination with hardware logic upon which the software executes) to emulate human intelligent functions. These intelligent systems apply human-like characteristics to convey and manipulate ideas which, when combined with the inherent strengths of digital computing, can solve problems with a high degree of accuracy (e.g., within a defined percentage range or above an accuracy threshold) and resilience on a large scale. A intelligent system may perform one or more computer-implemented intelligent operations that approximate a human thought process while enabling a user or a computing system to interact in a more natural manner. A intelligent system may comprise artificial intelligence logic, such as natural language processing (NLP) based logic, for example, and machine learning logic, which may be provided as specialized hardware, software executed on hardware, or any combination of specialized hardware and software executed on hardware. The logic of the intelligent system may implement the intelligent operation(s), examples of which include, but are not limited to, question answering, identification of related concepts within different portions of content in a corpus, and intelligent search algorithms, such as Internet web page searches.

In general, such intelligent systems are able to perform the following functions: 1) Navigate the complexities of human language and understanding; 2) Ingest and process vast amounts of structured and unstructured data; 3) Generate and evaluate hypotheses; 4) Weigh and evaluate responses that are based only on relevant evidence; 5) Provide situation-specific advice, insights, estimations, determinations, evaluations, calculations, and guidance; 6) Improve knowledge and learn with each iteration and interaction through machine learning processes; 7) Enable decision making at the point of impact (contextual guidance); 8) Scale in proportion to a task, process, or operation; 9) Extend and magnify human expertise and cognition; 10) Identify resonating, human-like attributes and traits from natural language; 11) Deduce various language specific or agnostic attributes from natural language; 12) Memorize and recall relevant data points (images, text, voice) (e.g., a high degree of relevant recollection from data points (images, text, voice) (memorization and recall)); and/or 13) Predict and sense with situational awareness operations that mimic human cognition based on experiences.

Additional aspects of the present invention and attendant benefits will be further described, following.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security parameters, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

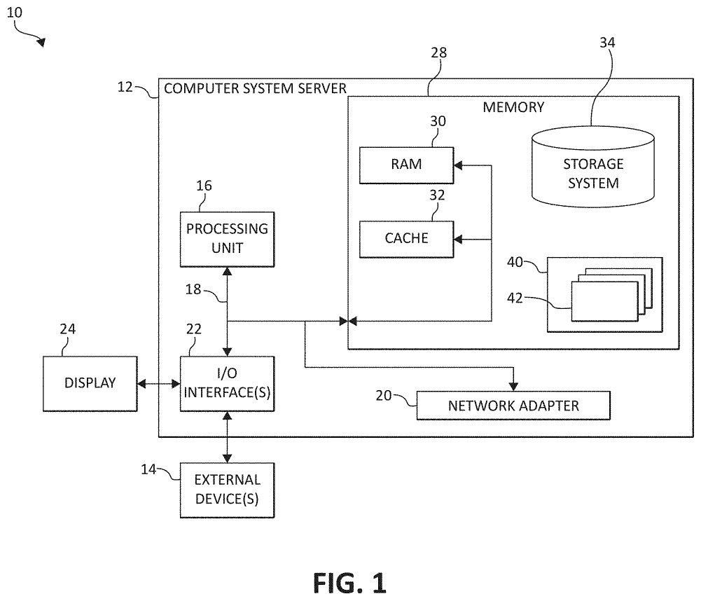

Referring now to FIG. 1, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, system memory 28 may include at least one program product having a set (e.g., at least one) of program modules that are configured to carry out the functions of embodiments of the invention.

Program/utility 40, having a set (at least one) of program modules 42, may be stored in system memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

In the context of the present invention, and as one of skill in the art will appreciate, various components depicted in FIG. 1 may be located in a moving vehicle. For example, some of the processing and data storage capabilities associated with mechanisms of the illustrated embodiments may take place locally via local processing components, while the same components are connected via a network to remotely located, distributed computing data processing and storage components to accomplish various purposes of the present invention. Again, as will be appreciated by one of ordinary skill in the art, the present illustration is intended to convey only a subset of what may be an entire connected network of distributed computing components that accomplish various inventive aspects collectively.

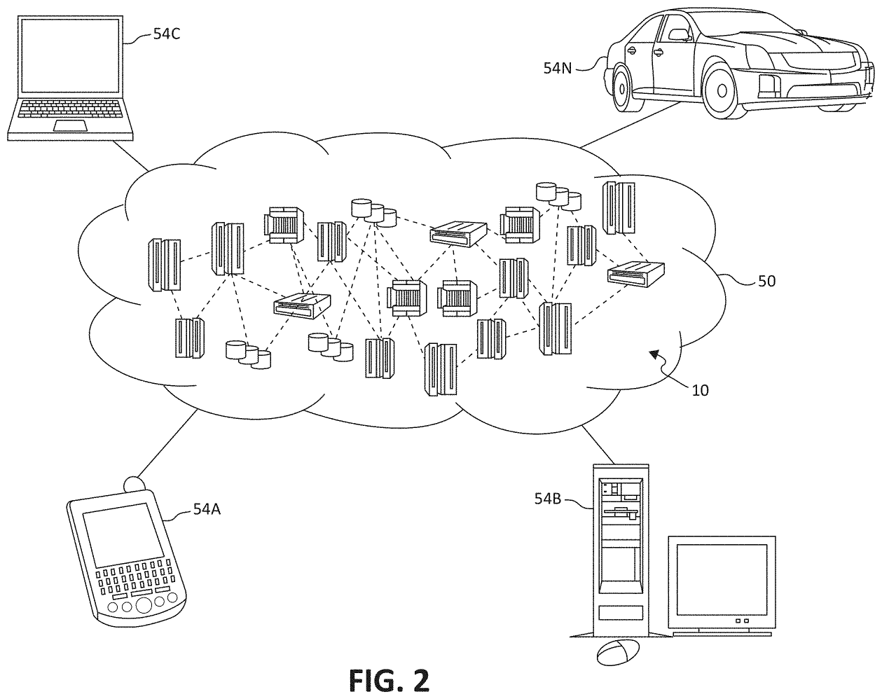

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

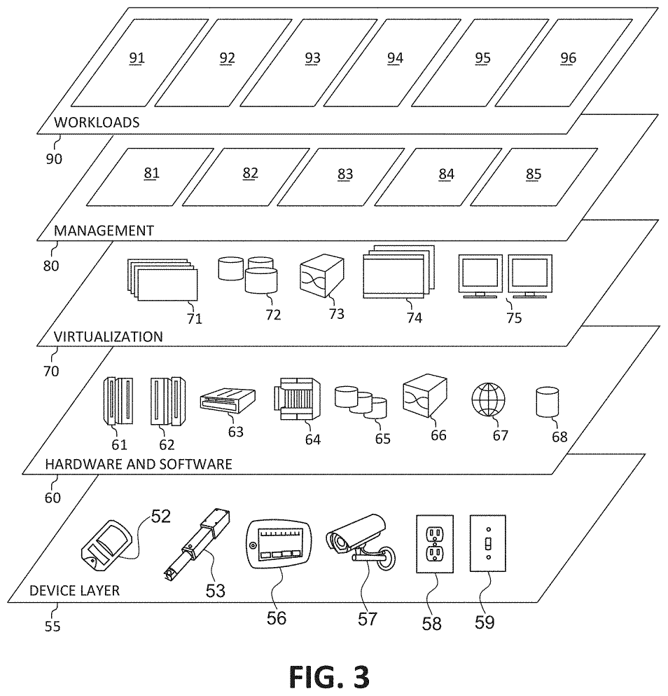

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Device layer 55 includes physical and/or virtual devices, embedded with and/or standalone electronics, sensors, actuators, and other objects to perform various tasks in a cloud computing environment 50. Each of the devices in the device layer 55 incorporates networking capability to other functional abstraction layers such that information obtained from the devices may be provided thereto, and/or information from the other abstraction layers may be provided to the devices. In one embodiment, the various devices inclusive of the device layer 55 may incorporate a network of entities collectively known as the “internet of things” (IoT). Such a network of entities allows for intercommunication, collection, and dissemination of data to accomplish a great variety of purposes, as one of ordinary skill in the art will appreciate.

Device layer 55 as shown includes sensor 52, actuator 53, “learning” thermostat 56 with integrated processing, sensor, and networking electronics, camera 57, controllable household outlet/receptacle 58, and controllable electrical switch 59 as shown. Other possible devices may include, but are not limited to various additional sensor devices, networking devices, electronics devices (such as a remote-control device), additional actuator devices, so called “smart” appliances such as a refrigerator or washer/dryer, and a wide variety of other possible interconnected objects.

Hardware and software layer 60 includes hardware and software components. Examples of hardware components include: mainframes 61; RISC (Reduced Instruction Set Computer) architecture-based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provides cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, in the context of the illustrated embodiments of the present invention, various workloads and functions 96 for providing intelligent advertisement campaign effectiveness and impact. One of ordinary skill in the art will appreciate that the workloads and functions 96 for providing intelligent advertisement campaign effectiveness and impact may also work in conjunction with other portions of the various abstractions layers, such as those in hardware and software 60, virtualization 70, management 80, and other workloads 90 (such as data analytics processing 94, for example) to accomplish the various purposes of the illustrated embodiments of the present invention.

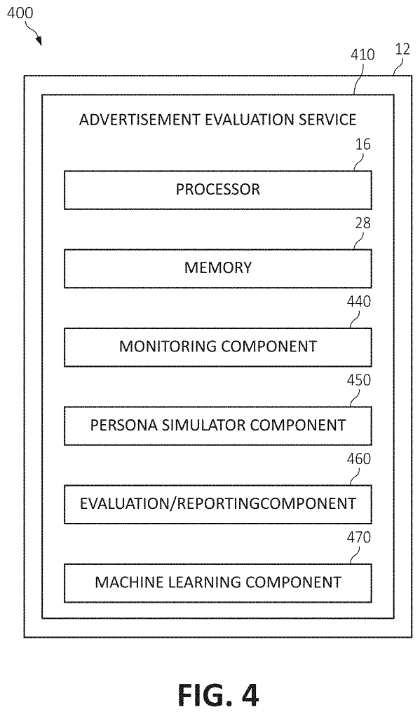

Turning now to FIG. 4, a block diagram depicting exemplary functional components of an intelligent system 400 according to various mechanisms of the illustrated embodiments is shown. In one aspect, one or more of the components, modules, services, applications, and/or functions described in FIGS. 1-3 may be used in FIG. 4. An intelligent system such as, for example, an advertisement evaluation service 410 is shown, incorporating processing unit 420 to perform various computational, data processing and other functionality in accordance with various aspects of the present invention. The advertisement evaluation service 410 may be provided by the computer system/server 12 of FIG. 1. The processing unit 420 may be in communication with memory 430. The advertisement evaluation service 410 may include a monitoring component 440, a persona simulator component 450, an evaluation/reporting component 460, and a machine learning component 470.

As one of ordinary skill in the art will appreciate, the depiction of the various functional units in advertisement evaluation service 410 is for purposes of illustration, as the functional units may be located within the advertisement evaluation service 410 or elsewhere within and/or between distributed computing components.

In one aspect, the monitoring component 440, in association with the persona simulator component 450, may identify a degree of impact and a degree of distribution of one or more communication campaigns upon a targeted entity according to a user persona, one or more communication rules, security factors, or a combination thereof.

The monitoring component 440, in association with the persona simulator component 450, may determine, as the degree of distribution, a number of times the one or more communication campaigns were delivered to the targeted entity according to one or more selected domains.

The monitoring component 440, in association with the evaluation/reporting component 460, may monitor and evaluate the one or more communication campaigns according to the one or more communication rules and security factors. The communication rules and security factors may be used to detect security breaches and inference attempts upon the one or more communication campaigns.

The machine learning component 470 may be used to extract one or more topics, sentiments, or a combination thereof based on the one or more communication campaigns.

The persona simulator component 450 may simulate behavior of the user persona. The user persona may include a description of a user obtained from a list of uniform resource locators (URLs), a frequency and probability of the user visiting one or more of a URLs from the list of the URLs, a list of interests relating to the user, activities and behaviors of the user associated with the list of the URLs, or a combination thereof.

The machine learning component 470, in association with the monitoring component 440 and/or persona simulator component 450, may manage classification of the one or more communication campaigns, and/or identify an intent or type of the one or more communication campaigns.

The machine learning component 470 initialize a machine learning operation to 1) discern the one or more communication campaigns as an advertisement, 2) learn and/or extract topics, semantics, categories, intent, or a combination thereof of the one or more communication campaigns, and/or identify a degree of polarity of the one or more communication campaigns in relation to the user person.

The machine learning component 470 may learn the one or more contextual factors, the user profiles, reinforced feedback learning, the user experience satisfaction level, or a combination thereof. For example, the machine learning component 470 may learn one or more types of media/advertisements that the user has accepted (e.g., preferred advertisements) and/or rejected (e.g., non-preferred advertisements) over a selected period of time. Thus, the machine learning component 470 may automatically accept and/or reject one or more learned types of media/advertisements that the user has previously accepted or rejected.

In one aspect, the machine learning component 470, as described herein, may be performed by a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, backpropagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are within the scope of this disclosure. Also, when deploying one or more machine learning models, a computing device may be first tested in a controlled environment before being deployed in a public setting. Also even when deployed in a public environment (e.g., external to the controlled, testing environment), the computing devices may be monitored for compliance.

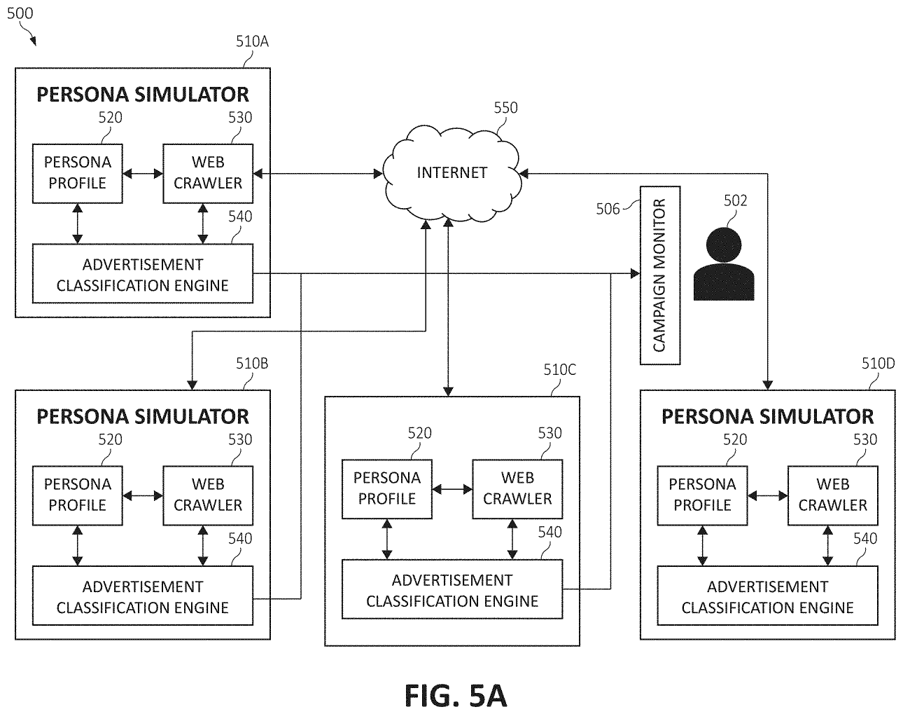

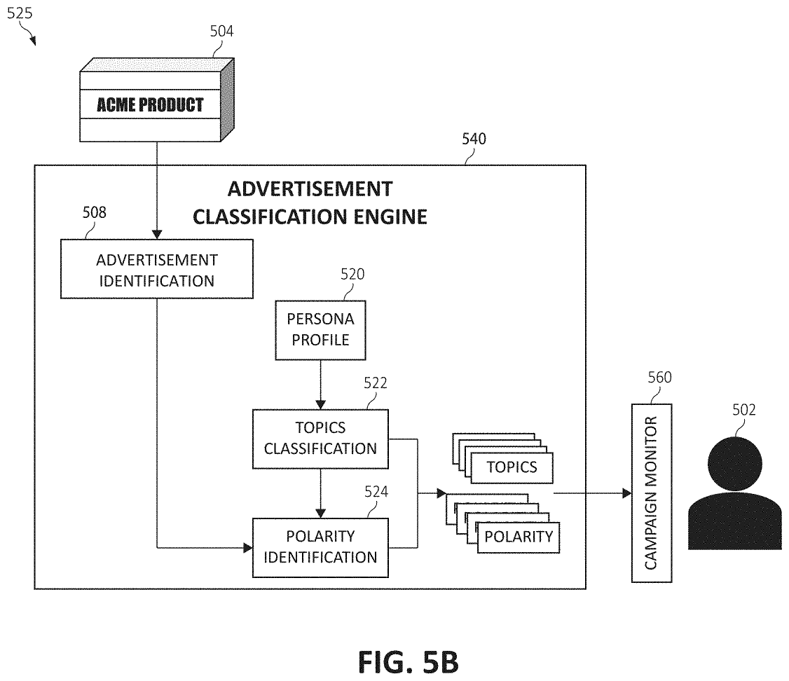

Turning now to FIGS. 5A-5B, a block diagram of exemplary functionality 500 and 525 relating to providing intelligent advertisement effectiveness and impact evaluation in a computing environment is depicted according to various aspects of the present invention. As shown, the various blocks of functionality are depicted with arrows designating the blocks' 500 relationships with each other and to show process flow. Additionally, descriptive information is also seen relating each of the functional blocks 500. As will be seen, many of the functional blocks may also be considered “modules” of functionality, in the same descriptive sense as has been previously described in FIG. 4. With the foregoing in mind, the module blocks 500 may also be incorporated into various hardware and software components of a system for intelligent advertisement effectiveness and impact evaluation in accordance with the present invention. Many of the functional blocks 500 may execute as background processes on various components, either in distributed computing components, or on the user device, or elsewhere, and generally unaware to the user performing generalized tasks.

As depicted in blocks 510A-D, persona simulators 510A-510D are depicted, each including a persona profile 520, a web crawler 530 (e.g., an URL search/crawler component), and an advertisement classification engine 540. Each of the persona simulators 510A-510D may be in communication with each other and an campaign monitor 506 via a communication network 550 such as, for example, an internet. Thus, an intelligent system (e.g., the advertisement evaluation service 410 of the intelligent system 400) may include the persona simulators 510A-510D and the campaign monitor 506 for the evaluation of online advertisements campaign.

The campaign monitor 506 may collect analytical data (e.g., the finding) of one or more of the persona simulators 510A-510D and reports the results in a comprehensible and consumable manner, to a user 502.

Each of the persona simulators 510A-510D may simulate the behavior and/or patterns of a user such as, for example, user 502 by reproducing access patterns, specified as a persona profile 520, to both publicly and privately available web resources that provide advertisements.

The persona profile 520 (in the persona simulators 510A-510D) may include data and/or a list of (web) resource identifiers with an associated probability of visiting, engaging, and/or interacting with a specific URL (e.g., website) and a description of how a user should interact with each web resource and a list of topics associated with the persona. That is, the persona profile 520 may include a descript of the persona of the user, which may be obtained from the list of URLs, a corresponding probability distribution of visiting the associated website, a description of how the persona behaves when visiting a website, and a list of topics relevant for the selected persona in the persona profile 520.

The web crawler 530 uses the persona profile 520 and reproduces and/or simulates the behavior and/or patters of the user (e.g., user 502) that accesses and interacts with the various selected online websites.

The advertisement classifier engine 540, as depicted in FIG. 5B, manages a classification of each of the advertisements (and/or advertisement campaigns) and the identification of how the advertisement related to the intent of the advertisement campaign such as, for example, a selected product 504 for which the advertisement campaigns. The advertisement classifier engine 540 may include three sub-components: 1) an advertisement discriminator (e.g., the advertisement identification component 508) to identify the advertisement and discern between advertisements and non-advertisements, 2) a semantic extractor 522 (e.g., topics classification) to extract the semantics, topics, sentiments, and/or intent of the advertisement, and/or polarity identifier 524 (e.g., polarity identification) to identify the polarity (e.g., negative and/or positive) of the advertisement with respect to the user profile.

To further illustrate, consider the following example in relation to a healthcare organization. Assume the healthcare organization desires to promote the increase in consumption of selected type of product for a group of persons within a selected age range. The organization uses the mechanisms of the illustrated embodiments by first defining characteristics of the people involved (e.g., students, business persons, etc.) and compiles persona profiles that will lead to the collection of advertisements presented to these type of person. A series of persona simulators may be created/spawned in vantage points defined by a required geographic coverage area. Information may be collected from each persona and each advertisement may be classified relative to the impact it has on the campaign: whether it is positive (e.g., advertisements showing the positive effects of the selected product) or negative (e.g., advertisements showing the negative effects of the selected product or showing negative habits caused by the selected product).

Information may then be sent/communicated back to the organization of interest with various feedback and/or statistics such as, for example, a number of positive and negative advertisements that were shown, a degree success (e.g., achieved an intended purpose or impact) of advertisements relative to their intent (e.g., users clicked on positive ads), and/or success of the campaign over time. The health organization can then select to improve the advertisement campaign, target different entities, and/or decide how to best invest in future advertisements and campaigns. The healthcare organization can also use the intelligent system, as described in FIGS. 4-5) to monitor advertisement trends such as, for example, seasonal patterns or other patterns over time.

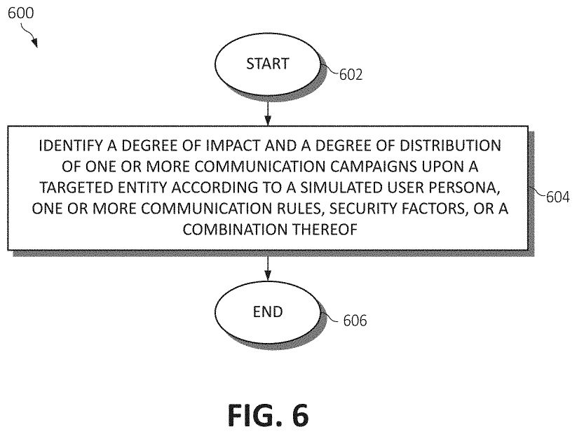

FIG. 6 is a flowchart diagram of an additional exemplary method for implementing intelligent advertisement effectiveness and impact evaluation in a computing environment by a processor. The functionality 600 may be implemented as a method executed as instructions on a machine, where the instructions are included on at least one computer readable medium or on a non-transitory machine-readable storage medium. The functionality 600 may start in block 602.

A degree of impact and a degree of distribution of one or more communication campaigns upon a targeted entity may be identified according to a user persona, one or more communication rules, security factors, or a combination thereof, as in block 604. The functionality 600 may end in block 606.

In one aspect, in conjunction with and/or as part of at least one block of FIG. 6, the operations of 600 may include each of the following. The operations of 600 may determine, as the degree of distribution, a number of times the one or more communication campaigns were delivered to the targeted entity according to one or more selected domains.

The operations of 600 may monitor and evaluate the one or more communication campaigns according to the one or more communication rules and security factors, wherein the one or more communication rules and security factors used to detect security breaches and inference attempts upon the one or more communication campaigns. In an additional aspect, the operations of 600 may further extract one or more topics, sentiments, or a combination thereof based on the one or more communication campaigns.

The operations of 600 may simulate behavior of the user persona, wherein the user persona includes a description of a user obtained from a list of uniform resource locators (URLs), a frequency and probability of the user visiting one or more of a URLs from the list of the URLs, a list of interests relating to the user, activities and behaviors of the user associated with the list of the URLs, or a combination thereof.

The operations of 600 may manage classification of the one or more communication campaigns and/or identify an intent or type of the one or more communication campaigns.

The operations of 600 may initialize a machine learning operation to discern the one or more communication campaigns as an advertisement, learn or extract topics, semantics, categories, intent, or a combination thereof of the one or more communication campaigns, and/or identify a degree of polarity of the one or more communication campaigns in relation to the user person.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowcharts and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowcharts and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowcharts and/or block diagram block or blocks.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts or carry out combinations of special purpose hardware and computer instructions.

1. A method, by a processor, for implementing intelligent advertisement effectiveness and impact evaluation in computing environment, comprising:
monitoring user access patterns as a user accesses various webpages over a selected period of time, wherein the user access patterns are inclusive of advertisements accepted and rejected by the user while accessing the various webpages;
training a machine learning component according to the user access patterns, wherein the training includes teaching the machine learning component to identify specific types of those of the advertisements accepted and rejected by the user using reinforced feedback learning;
creating a user persona for the user based on the user access patterns, wherein the user persona includes a persona profile having characteristic and demographic information of the user;
simulating the user persona by an automated web crawler, using the trained machine learning component, to reproduce the user access patterns of accessing the various webpages while automatically monitoring one or more communication campaigns promoted to the user persona during the accessing; and
identifying a degree of impact and a degree of distribution of the one or more communication campaigns upon a targeted entity according to the user persona, one or more communication rules, security factors, or a combination thereof.

2. The method of claim 1, further including determining, as the degree of distribution, a number of times the one or more communication campaigns were delivered to the targeted entity according to one or more selected domains.

3. The method of claim 1, further including:
monitoring and evaluating the one or more communication campaigns according to the one or more communication rules and security factors, wherein the one or more communication rules and security factors used to detect security breaches and inference attempts upon the one or more communication campaigns.

4. The method of claim 1, further including extracting one or more topics, sentiments, or a combination thereof based on the one or more communication campaigns.

5. The method of claim 1, wherein the user persona includes a description of a user obtained from a list of uniform resource locators (URLs), a frequency and probability of the user visiting one or more of a URLs from the list of the URLs, a list of interests relating to the user, activities and behaviors of the user associated with the list of the URLs, or a combination thereof.

6. The method of claim 1, further including:
classifying the one or more communication campaigns as the advertisements or non-advertisements; and
identifying an intent or type of the one or more communication campaigns.

7. The method of claim 1, wherein training the machine learning component further includes initializing a machine learning operation to:
discern the one or more communication campaigns as an advertisement;
learn or extract topics, semantics, categories, intent, or a combination thereof of the one or more communication campaigns; and
identify a degree of polarity of the one or more communication campaigns in relation to the user persona.

8. A system for implementing intelligent advertisement effectiveness and impact evaluation in a computing environment, comprising:
one or more computers with executable instructions that when executed cause the system to:
monitor user access patterns as a user accesses various webpages over a selected period of time, wherein the user access patterns are inclusive of advertisements accepted and rejected by the user while accessing the various webpages;
train a machine learning component according to the user access patterns, wherein the training includes teaching the machine learning component to identify specific types of those of the advertisements accepted and rejected by the user using reinforced feedback learning;
create a user persona for the user based on the user access patterns, wherein the user persona includes a persona profile having characteristic and demographic information of the user;
simulate the user persona by an automated web crawler, using the trained machine learning component, to reproduce the user access patterns of accessing the various webpages while automatically monitoring one or more communication campaigns promoted to the user persona during the accessing; and
identify a degree of impact and a degree of distribution of the one or more communication campaigns upon a targeted entity according to the user persona, one or more communication rules, security factors, or a combination thereof.

9. The system of claim 8, wherein the executable instructions further determine, as the degree of distribution, a number of times the one or more communication campaigns were delivered to the targeted entity according to one or more selected domains.

10. The system of claim 8, wherein the executable instructions further:
monitor and evaluate the one or more communication campaigns according to the one or more communication rules and security factors, wherein the one or more communication rules and security factors used to detect security breaches and inference attempts upon the one or more communication campaigns.

11. The system of claim 8, wherein the executable instructions further extract one or more topics, sentiments, or a combination thereof based on the one or more communication campaigns.

12. The system of claim 8, wherein the user persona includes a description of a user obtained from a list of uniform resource locators (URLs), a frequency and probability of the user visiting one or more of a URLs from the list of the URLs, a list of interests relating to the user, activities and behaviors of the user associated with the list of the URLs, or a combination thereof.

13. The system of claim 8, wherein the executable instructions further:
classifying the one or more communication campaigns as the advertisements or non-advertisements; and
identify an intent or type of the one or more communication campaigns.

14. The system of claim 8, wherein wherein training the machine learning component further includes initializing a machine learning operation to:
discern the one or more communication campaigns as an advertisement;
learn or extract topics, semantics, categories, intent, or a combination thereof of the one or more communication campaigns; and
identify a degree of polarity of the one or more communication campaigns in relation to the user persona.

15. A computer program product for implementing intelligent advertisement effectiveness and impact evaluation in a computing environment by a processor, the computer program product comprising a non-transitory computer-readable storage medium having computer-readable program code portions stored therein, the computer-readable program code portions comprising:
an executable portion that monitors user access patterns as a user accesses various webpages over a selected period of time, wherein the user access patterns are inclusive of advertisements accepted and rejected by the user while accessing the various webpages;
an executable portion that trains a machine learning component according to the user access patterns, wherein the training includes teaching the machine learning component to identify specific types of those of the advertisements accepted and rejected by the user using reinforced feedback learning;
an executable portion that creates a user persona for the user based on the user access patterns, wherein the user persona includes a persona profile having characteristic and demographic information of the user;
an executable portion that simulates the user persona by an automated web crawler, using the trained machine learning component, to reproduce the user access patterns of accessing the various webpages while automatically monitoring one or more communication campaigns promoted to the user persona during the accessing; and
an executable portion that identifies a degree of impact and a degree of distribution of the one or more communication campaigns upon a targeted entity according to the user persona, one or more communication rules, security factors, or a combination thereof.

16. The computer program product of claim 15, further including an executable portion that determines, as the degree of distribution, a number of times the one or more communication campaigns were delivered to the targeted entity according to one or more selected domains.

17. The computer program product of claim 15, further including an executable portion that:
monitors and evaluates the one or more communication campaigns according to the one or more communication rules and security factors, wherein the one or more communication rules and security factors used to detect security breaches and inference attempts upon the one or more communication campaigns.

18. The computer program product of claim 15, further including an executable portion that extracts one or more topics, sentiments, or a combination thereof based on the one or more communication campaigns.

19. The computer program product of claim 15,
wherein the user persona includes a description of a user obtained from a list of uniform resource locators (URLs), a frequency and probability of the user visiting one or more of a URLs from the list of the URLs, a list of interests relating to the user, activities and behaviors of the user associated with the list of the URLs, or a combination thereof; and
further including an executable portion that:
classifies the one or more communication campaigns as the advertisements or non-advertisements; or
identifies an intent or type of the one or more communication campaigns.

20. The computer program product of claim 15, wherein training the machine learning component further includes initializing a machine learning operation to:
discern the one or more communication campaigns as an advertisement;
learn or extract topics, semantics, categories, intent, or a combination thereof of the one or more communication campaigns; and
identify a degree of polarity of the one or more communication campaigns in relation to the user persona.
